(19) United States
(12) Patent Application Publication
(10) Pub. No.: US 2011/0284610 A1
(43) Pub. Date: Nov. 24, 2011

(54) CARRYING APPARATUS MANUFACTURING PROCESS

(76) Inventors: Kathleen Marie Miller, Salt Lake City, UT (US); Corey Michael La Forge, Salt Lake City, UT (US)

(21) Appl. No.: 12/784,072

(22) Filed: May 20, 2010

(51) Int. Cl. A45F 3/04; B32B 37/06

(52) U.S. Cl. 224/676; 156/73.4

(57) ABSTRACT

The present invention relates to carrying apparatus manufacturing processes. One embodiment of the present invention relates to a method for coupling materials of dissimilar stiffness on a carrying apparatus. The method includes adhering a cover fabric member to a base fabric member of different stiffness using applied sandwich pressure and high frequency transmission. The high frequency transmission may include translating the fabric members so as to sequentially straddle a high frequency wheel along a perimeter of the cover fabric member. An adhesive agent is disposed between the cover fabric member and the base fabric member. The adhesion between the fabric members is configured to exceed a peel test tolerance of ten pounds. In addition, optional acts of applying high and low temperatures may be included to pre-tack the cover fabric member to the base fabric member.

### FIELD OF THE INVENTION

The invention generally relates to carrying apparatus manufacturing processes. In particular, the present invention relates to a seamless thermo activated fabric adhesive coupling process incorporating high frequency welding for the manufacture of a carrying apparatus.

### BACKGROUND OF THE INVENTION

The construction of soft goods includes the act of stitching or sewing pieces of material together so as to form particular shapes or enclosures. For example, the construction of a backpack involves stitching together one or more fabric members to form a main compartment. Conventional sewing and stitching techniques utilize visible thread materials to couple the materials so as to form the desired shape. However, visible threads are aesthetically unattractive and do not provide watertight sealing without additional adhesives. In addition, stitched and/or sewn seams may also leak, deteriorate, and/or fail.

Various glue-based welding techniques have been developed to adhere fabric pieces or regions to one another. For example, welded (seamless) waterproof external pockets on soft shell jackets generally utilize thermo-activated adhesives and heating processes to weld a piece of material on the outside of the jacket, thereby forming the pocket. One particular type of glue and heating process is overlap bonding, which includes attaching and heating an adhesive agent along the outer perimeter (seam allowance) of the base fabric region. Glue and heating processes utilize conventional heat presses that apply pressure and heat to a region so as to activate and engage the glue adhesion. The glue and heating processes used in apparel manufacturing to attach external pockets on soft textured fabrics provide sufficient adhesion to support structural attachments, partly due to the fabric texture, porosity and composition. However, conventional adhesive processes on stiffer pack fabrics/cloths are generally insufficient to create secure structural and reliable seams/bonds due to the tighter fabric weaves and heavy fabric coatings. The fabric coatings may generally have a rating of 50 grm PU or greater on the one side and a strong DWR on the other side. Conventional glue and heating processes on stiffer pack fabrics/cloth do not create sufficient bond strength to independently attach a handle on a backpack or duffle bag. Therefore, conventional stitched construction may be utilized in conjunction with seamless adhesive techniques to provide the sufficient structural integrity. Seamless panels may be glued over conventional structural stitch regions to give the appearance of a seamless attachment and to provide a water-resistant seal.

Existing high frequency methods (welding) have been successfully utilized to independently adhere stiffer fabric materials to one another. For example, dry bags and rafts made of vinyl or urethane have been manufactured with high frequency methods to bond the similar materials together without the need for additional independent chemicals or adhesives for structural bonding of these fabric members. However, existing attempts to utilize these techniques in backpack construction require that both sides of the fabric have a PU (polyurethane) coating to be welded together and to introduce a thermo-activated adhesive to join the PU coatings together. This technique significantly increases the overall weight of the carrying device thereby reducing the overall functionality of the backpack. In addition, when PU coatings are exposed to environmental elements on the outside of a carrying device, they tend to peel and yellow creating an undesirable appearance and compromise the welded structure. Further, coating the welded fabric members with PU coatings significantly stiffens the resulting product. Therefore, the necessary coatings needed to utilize existing adhesion methods are impractical for backpack and other constructions that require adhesion between fabric members of dissimilar stiffness. Backpacks and other carrying devices are constructed of stiffer fabric materials so as to be more abrasion resistant and durable. In addition, backpacks are subject to higher loads and must be constructed of materials that have a high tensile strength. Various panels and straps are attached to backpacks to provide structural attachment and support of one or more compartments or external accessories. External carrying device panels may have the same stiffness as the main body. Conventional heat and gluing techniques fail to achieve the proper adhesion with materials of dissimilar stiffness and composition without causing undesirable effects such as delamination, noticeable excessive glue outflow, bubbling, puckering, etc.

Therefore, there is a need in the industry for a method for seamless coupling for fabrics of dissimilar stiffness in the construction of a carrying apparatus such as a backpack or a bag.

### SUMMARY OF THE INVENTION

The present invention relates to carrying apparatus manufacturing processes. One embodiment of the present invention relates to a method for coupling materials of dissimilar stiffness on a carrying apparatus. The method includes adhering a cover fabric member to a base fabric member of different stiffness using applied sandwich pressure and high frequency transmission. The base and/or cover fabric member may be composed of a flexible, water-resistant material. The high frequency transmission may include translating the fabric members so as to sequentially straddle a high frequency wheel along a perimeter of the cover fabric member. An adhesive agent is disposed between the cover fabric member and the base fabric member. The adhesion between the fabric members may be configured to exceed an average peeling resistance of at least 10 pounds per inch according to Federal Test Method standard 191A/5970, Peel test ASTM 2724, and Shear test ASTM 5034. In addition, optional acts of applying high and low temperatures may be included to pre-tack the cover fabric member to the base fabric member. A second embodiment of the present invention relates to a carrying device including a cover fabric member adhered to a base fabric member using applied sandwich pressure and transmission of high frequency.

Embodiments of the present invention represent a significant advance in the field of fabric adhesion. Conventional seamless fabric adhesion techniques applied between typical pack cloth/fabrics, fail to reliably adhere materials to one another when one or both of the materials are stiff such as plastic, nylon or polyurethane fabrics with a high density weave. Existing seamless fabric adhesion systems rely exclusively on the application of heat and pressure and time to activate a thermo-activated adhesive agent between fabric layers. Embodiments of the present invention incorporate the use of high frequency transmission through the fabric layers at specific parameters configured to reliably adhere fabrics with significantly dissimilar stiffness characteristics. The application of high frequency transmission avoids the common problems of external glue residue, weak peel test results, and non-uniform adhesion.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. In the Figures, the physical dimensions may be exaggerated for clarity. The same reference numerals in different drawings represent the same element, and thus their descriptions will be omitted.

FIG. 1 illustrates a perspective view of a flow chart in accordance with embodiments of the present invention;

FIG. 2 illustrates the application of high frequency waves upon a cover fabric member in accordance with the embodiment of the present invention illustrated in FIG. 1;

FIG. 3 illustrates a carrying system including at least one cover fabric member adhered to a base fabric member manufactured via a process including high frequency transmission in accordance with embodiments of the present invention; and

FIG. 4 illustrates a second carrying system including at least one cover fabric member adhered to a base fabric member manufactured via a process including high frequency transmission in accordance with embodiments of the present invention.

### DETAILED DESCRIPTION OF THE INVENTION

The present invention relates to carrying apparatus manufacturing processes. One embodiment of the present invention relates to a method for coupling materials of dissimilar stiffness on a carrying apparatus. The method includes adhering a cover fabric member to a base fabric member of different stiffness using applied sandwich pressure and high frequency transmission. The base and/or cover fabric member may be composed of a flexible water resistant material. The high frequency transmission may include translating the fabric members so as to sequentially straddle a high frequency wheel along a perimeter of the cover fabric member. An adhesive agent is disposed between the cover fabric member and the base fabric member. The adhesion between the fabric members may be configured to exceed an average peeling resistance of at least 10 pounds per inch according to Federal Test Method standard 191A/5970, Peel test ASTM 2724, and Shear test ASTM 5034. In addition, optional acts of applying high and low temperatures may be included to pre-tack the cover fabric member to the base fabric member. A second embodiment of the present invention relates to a carrying device including a cover fabric member adhered to a base fabric member using applied sandwich pressure and transmission of high frequency. Also, while embodiments are described in reference to carrying devices, it will be appreciated that the teachings of the present invention are application to other areas such as the manufacturing of other soft goods including but not limited to apparel.

The following terms are defined as follows:

### DEFINITIONS

Fabric member—A region of a fabric-like material having a particular stiffness and composition. For example, a low stiffness fabric member may be composed of low density nylon, whereas a high stiffness fabric member may be composed of high density nylon with a heavy polyurethane coating backer.

Adhesive agent—A chemical bonding agent or glue configured to chemically bond multiple members. An adhesive agent may require activation through some form of reactive process including but not limited to heat, pressure, etc.

Heat resistant layer—a layer of material that is substantially resistant to heat application.

Peel test tolerance—A force related test involving the necessary force to peel apart two fabric members according to Federal Test Method Standard 191A/5970.

Heat press—A manufacturing apparatus configured to apply both high temperature and pressure.

Cool press—A manufacturing apparatus configured to apply both low temperature and pressure.

High frequency welding machine—A manufacturing apparatus configured to apply high frequency waves via a rotating wheel member.

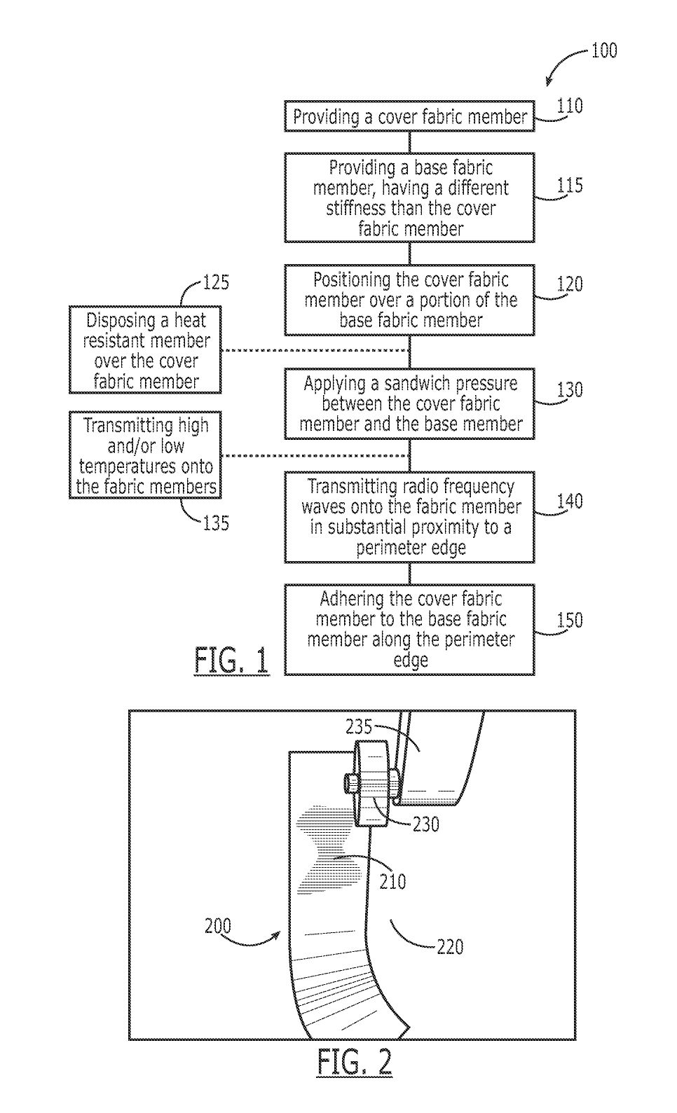

Reference is initially made to FIG. 1, which illustrates a flowchart of a method for coupling materials of dissimilar stiffness on a carrying apparatus, designated generally at 100. A carrying apparatus may be any form of apparatus configured to transport items within a substantially enclosed inner region. For example, a backpack is one type of carrying device configured to be worn by a user via at least two shoulder straps. Backpacks generally include various external pockets and couplers. Embodiments of the method 100 may be utilized to adhere fabric members to the external side of a backpack. It will be appreciated that numerous additional acts of manufacturing a carrying apparatus may be included in accordance with embodiments of the present invention. The illustrated method 100 includes providing a cover fabric member, act 110. The cover fabric member is any form of fabric material having a particular stiffness and composition. For a carrying apparatus, the fabric member may be composed of an abrasion resistant, nylon-type material. A base fabric member is provided, having a higher stiffness than the cover fabric member, act 115. Alternatively, the base fabric member may be composed of a material having a lower stiffness than the cover fabric member. The base fabric member forms a substantial portion of the carrying apparatus and is composed of a fabric material that is abrasion resistant. For example, the base fabric member may be composed of a 400 Denier nylon material which is generally considered a high stiffness material. The cover or base fabric member may further include a polyurethane backer of approximately 50 grams and an adhesive agent applied to one of the sides. Various well known acts for applying the adhesive agent to either cover or base fabric member may include the application of heat and/or pressure via a heat press. The specific parameters for applying the adhesive agent depend on its composition and the particular fabric member upon which it is applied. This initial process of applying the adhesive agent may be referred to as “initial tacking”.

In accordance with embodiments of the present invention, any adhesive agent may be used. However, the illustrated process may be optimized with the use of a polyurethane and copolymer based glue specifically formulated to activate at low temperatures of 120-150 degrees Celsius. The adhesive agent manufacturer's product number for one such formulation is BD11-1002415/06M.

The cover fabric member is positioned over a portion of the base fabric member, act 120. Specific positioning of the cover fabric member over the base fabric member depends on the type of bonding or accessory to which the method is applied. For example, the method 100 is used to adhere a pocket region to the external side of the carrying apparatus, the cover fabric member is positioned in the specific location at which the pocket is to be located on the base fabric member. The cover fabric member is specifically oriented so that an adhesion side is disposed adjacent to the base fabric member. The adhesion side of the cover fabric member may include the adhesive agent or may be configured to receive the adhesive agent from the base fabric member. A perimeter edge of the cover fabric member is also specifically aligned on the base fabric member.

A sandwich pressure is applied between the cover fabric member and the base fabric member, act 130. The sandwich pressure may be applied using a conventional press type machine. Various levels of pressure may be applied depending on the specific adhesive agent and composition of the fabric members. One optimal pressure setting range for embodiments of the present invention includes 1-7 kg/cm². In addition, the time duration over which the sandwich pressure is applied may further be adjusted according to the specific parameters. One optimal pressure duration range is approximately 5-30 seconds. An optional act includes disposing a heat resistant member over the cover fabric member, act 125. One type of heat resistant material may be release paper. The optional heat resistant member may help direct/contain adhesive agent activation and minimize undesirable glue disbursement. Another optional act includes transmitting high and/or low temperatures onto the fabric members, act 135. The transmission of high and/or low temperatures may be in conjunction with the act of applying the pressure via a hand iron, a hot press, and/or a cold press machine. One set of parameters may include applying high temperatures within a range of 100-150 degrees Celsius for between 10-60 seconds and then subsequently applying low temperatures of 0-20 degrees Celsius for between 10-60 seconds. The acts described above may be referred to as “pretacking” the fabric members together.

It will be appreciated that various acts may be combined and/or repeated in accordance with embodiments of the present invention. For example, the act of applying a sandwich pressure may be performed in conjunction with the transmission of a high temperature and then again with the transmission of a low temperature. Conventional chemical fabric adhesion methods utilize temperature and pressure exclusively for activation of the adhesive agent. In contrast, embodiments of the present invention further include the act of high frequency transmission upon the fabric members discussed below.

A set of high frequency waves is transmitted onto the cover fabric member along the perimeter edge, act 140. The high frequency waves may be transmitted by a specialized welding machine incorporating direct application via wheel member 230 (see FIG. 2). In particular, the wheel member 230 is routed along the perimeter edge of the cover member to direct the high frequency transmission between the cover and base fabric member. The high frequency welding machine may be set at a reduced intensity within a range of 30-70% for optimal adhesion of the dissimilar fabric members. Further, the high frequency waves may be within a range of 20 to 40 Megahertz.

The cover fabric member is adhered to the base fabric member along the perimeter edge, act 150. The fabric members are adhered to a peel test tolerance rating of at least ten pounds. The process of adhesion of the fabric members includes activation of the adhesive agent.

Reference is next made to FIG. 2, which further illustrates one embodiment of the act of applying high frequency waves in accordance with the flowchart illustrated in FIG. 1. The illustrated act 200 includes a cover fabric member 210 and a base fabric member 220. A high frequency welding apparatus includes an arm 235 and a wheel 230. The wheel 230 is shown rolling/routing along a perimeter edge of the cover fabric member 210 so as to transmit high frequency waves through the cover fabric member 210. An operator performs the routing process by translating the carrying apparatus.

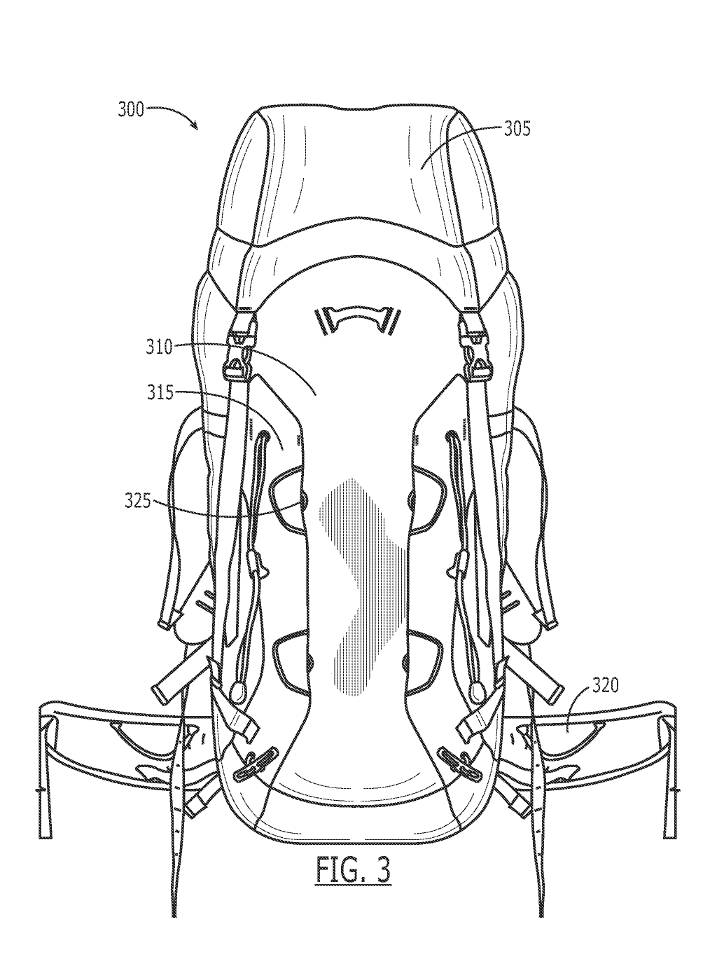

Reference is next made to FIG. 3, which illustrates a carrying apparatus manufactured in accordance with embodiments of the present invention, designated generally at 300. The carrying apparatus 300 is a backpack composed primarily of a base fabric member 310. The base fabric member 310 forms a partially enclosed region within which a user may dispose items for transportation. A lid or cover 305 is configured to selectively cover an opening to the partially enclosed region. The backpack 300 includes a cover fabric member 315 externally coupled to the base fabric member 310 via a process including the activation of an adhesive agent with high frequency transmission.

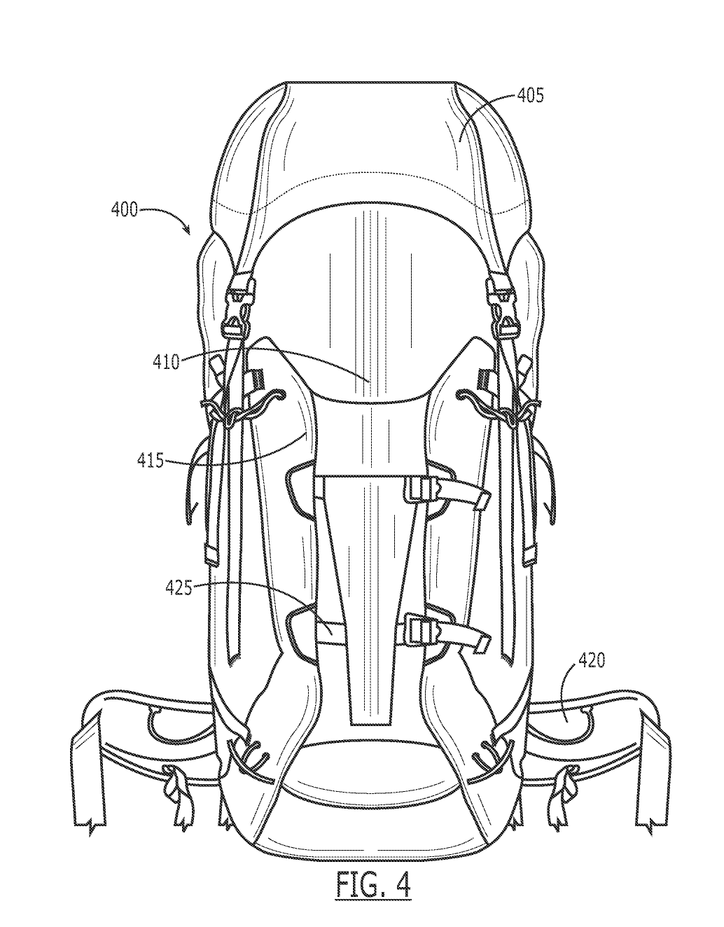

Reference is next made to FIG. 4, which illustrates a second carrying apparatus manufactured in accordance with embodiments of the present invention, designated generally at 400. The carrying apparatus 400 is a backpack composed primarily of a base fabric member 410. The base fabric member 410 forms a partially enclosed region within which a user may dispose items for transportation. A lid or cover 405 is configured to selectively cover an opening to the partially enclosed region. The backpack 400 includes a cover fabric member 415 externally coupled to the base fabric member 410 via a process including the activation of an adhesive agent with high frequency transmission.

It should be noted that various alternative system designs may be practiced in accordance with the present invention, including one or more portions or concepts of the embodiment illustrated in FIG. 1 or described above. Various other embodiments have been contemplated, including combinations in whole or in part of the embodiments described above.

What is claimed is:

1. A method for coupling fabric regions on a carrying apparatus comprising the acts of:
providing a cover fabric member, wherein the fabric member includes a top side and an adhesion side, and a perimeter edge;
providing a base fabric member, wherein the base fabric member has a substantially different stiffness than the cover fabric member, and wherein at least one of the adhesion side of the cover fabric member and the base fabric member includes an adhesive agent;
positioning the adhesion side of the cover fabric member over a portion of the base fabric member;
applying a sandwich pressure between the top side of the cover fabric member and the base member in substantial proximity to the perimeter edge;
transmitting high frequency waves onto the top side of the cover fabric member in substantial proximity to the perimeter edge including activating the adhesive agent; and
adhering the cover fabric member to the base fabric member along the perimeter edge.

2. The method of claim 1, further including the act of transmitting heat onto the top side of the cover fabric member in substantial proximity to the perimeter edge prior to the act of transmitting high frequency waves.

3. The method of claim 2, wherein the act of transmitting heat includes transmitting heat within a range of 100-150 degrees Celsius.

4. The method of claim 2, wherein the act of transmitting heat includes transmitting heat through a heat resistant layer.

5. The method of claim 2, wherein the act of transmitting heat includes transmitting heat for a period between 10 and 45 seconds.

6. The method of claim 2, wherein the act of transmitting heat further includes subsequently applying a temperature within the range of 0-20 degrees Celsius for a period between 20 and 60 seconds.

7. The method of claim 1, wherein the act of applying a sandwich pressure includes applying a pressure within the range of 1-7 kilograms per square centimeter.

8. The method of claim 1, wherein the act of transmitting high frequency waves includes transmitting high frequency waves at a device intensity within the range of 30-70%.

9. The method of claim 1, wherein the act of transmitting high frequency waves includes transmitting high frequency waves within the frequency range of 20 Megahertz to 40 Megahertz.

10. The method of claim 1, wherein the act of transmitting high frequency waves onto the top side of the cover fabric member in substantial proximity to the perimeter edge includes transmitting high frequency waves via a high frequency welding wheel member.

11. The method of claim 10, wherein the act of transmitting high frequency waves onto the top side of the cover fabric member in substantial proximity to the perimeter edge further includes translating the base fabric member and the cover fabric member so as to straddle the RF Welding wheel member along the perimeter edge of the cover fabric member and an adjacent portion of the base fabric member.

12. The method of claim 1, wherein the act of adhering the cover fabric member to the base fabric member along the perimeter edge includes adhering the perimeter edge to a peel test tolerance of at least ten pounds with respect to the base fabric member.

13. The method of claim 1, wherein the at least one of the base fabric member and the cover fabric member are composed of a water resistant material with a polyurethane coating.

14. The method of claim 1, wherein the adhesive agent on the adhesive side of the cover member includes polyurethane and copolymer.

15. A method for coupling fabric regions on a backpack comprising the acts of:
providing a cover fabric member, wherein the fabric member includes a top side and an adhesion side, and a perimeter edge;
providing a base fabric member, wherein the base fabric member has a substantially different stiffness than the cover fabric member, and wherein at least one of the adhesion side of the cover fabric member and the base fabric member includes an adhesive agent;
positioning the adhesion side of the cover fabric member over a portion of the base fabric member;
applying a sandwich pressure between the top side of the cover fabric member and the base member in substantial proximity to the perimeter edge;
transmitting high frequency waves onto the top side of the cover fabric member in substantial proximity to the perimeter edge via a high frequency welding wheel member including translating the base fabric member and the cover fabric member so as to straddle the high frequency welding wheel member along the perimeter edge of the cover fabric member and an adjacent portion of the base fabric member including activating the adhesive agent; and
adhering the cover fabric member to the base fabric member along the perimeter edge to a peel test tolerance of at least ten pounds with respect to the base fabric member.

16. The method of claim 15, further including the act of transmitting heat onto the top side of the cover fabric member in substantial proximity to the perimeter edge prior to the act of transmitting high frequency waves.

17. A carrying device comprising:
a cover fabric member, wherein the fabric member includes a top side and an adhesion side, and a perimeter edge;
a base fabric member, wherein the base fabric member has a higher stiffness than the cover fabric member, and wherein the base fabric member forms a substantially enclosed region, and wherein the base fabric member has an internal side adjacent to the substantially enclosed region and an external side opposite of the internal side, and wherein at least one of the adhesion side of the cover fabric member and the base fabric member includes an adhesive agent;
wherein the cover fabric member is adhered to the external side of the base fabric member along the perimeter to a peel test tolerance of at least ten pounds per inch via the activation of the adhesive agent including the transmission of high frequency waves and a sandwich pressure across the cover fabric member and the base fabric member.

18. The carrying device of claim 17, wherein the carrying device is a backpack including two shoulder strap members and wherein at least one of the base fabric member and the cover fabric member are composed of a water resistant material with a polyurethane coating.

19. The carrying device of claim 17, wherein the cover fabric member is further adhered to the external side of the base fabric via the transmission of a temperature within the range of 100 to 150 degrees Celsius for a period of 10 to 45 seconds and subsequently the transmission of a temperature within the range of 0 to 20 degrees Celsius for a period of 20 to 60 seconds.

20. The carrying device of claim 17, wherein the adhesive agent includes a polyurethane and copolymer composition configured to adhere fabrics at a range between 100 and 150 degrees Celsius.
